(19) United States
(12) Patent Application Publication
(10) Pub. No.: US 2025/0055540 A1
(43) Pub. Date: Feb. 13, 2025

(54) METHOD AND APPARATUS FOR ACHIEVING MODEL COMPATIBILITY IN TWO-SIDED MODEL AND ITS PARAMETER SIGNALING

(71) Applicant: INDIAN INSTITUTE OF TECHNOLOGY MADRAS (IIT Madras), Tamil Nadu (IN)

(72) Inventors: Radhakrishna Ganti, Tamil Nadu (IN); Venkata Siva Sai Prasad Pirati, Tamil Nadu (IN); Anil Kumar Yerrapragada, Telangana (IN); Jeeva Keshav Sattianarayanin, Puducherry (IN)

(73) Assignee: INDIAN INSTITUTE OF TECHNOLOGY MADRAS (IIT Madras), Tamil Nadu (IN)

(21) Appl. No.: 18/799,582

(22) Filed: Aug. 9, 2024

(30) Foreign Application Priority Data
Aug. 11, 2023 (IN) 202341054171
Sep. 29, 2023 (IN) 202341065834

(51) Int. Cl. H04B 7/06; H04B 17/391; H04W 8/22

(52) U.S. Cl. CPC H04B 7/0626; H04B 7/0658; H04B 17/3913; H04W 8/22

(57) ABSTRACT

The present invention provides a method and apparatus for achieving model compatibility in AI/ML based channel state information compression models in multi-antenna systems. An initial capability report is transmitted to a base station. An initial network configuration is received from the base station. An AI-specific AI/ML CSI capability report is transmitted to the base station. A CSI report configuration consisting of AI/ML model specific configuration parameters and CSI reporting parameters, and CSI-Reference signals are received from the base station. Parameters such as AI-CSI is computed based on the CSI report configuration to transmit CSI report. The CSI report configuration is transmitted according to an information element (IE) consisting of a pairing ID. The AI-CSI parameter is computed based on AI/ML model indicated by the pairing ID and other CSI reporting parameters included in the CSI report configuration.

### CROSS-REFERENCE TO RELATED APPLICATIONS

This application claims priority pursuant to India patent application No. 202341054171, filed Aug. 11, 2023 and India patent application No. 202341065834, filed Sep. 29, 2023, which applications are incorporated herein by reference in its entirety.

### FIELD OF THE INVENTION

The present invention generally relates to application of Artificial Intelligence or Machine Learning (AI/ML) techniques for compressing Channel State Information (CSI) in wireless communications network. More particularly, the present invention relates to method and apparatus for achieving model compatibility in AI/ML based channel state information compression models improving compatibility of AI/ML based channel state information compression models (two-sided models) in multi-antenna systems (MIMO) and to improved signaling of parameters in such systems.

### BACKGROUND OF THE INVENTION

Recent years have seen exponential growth in the use of artificial intelligence and machine learning in wireless communication networks and the same is expected to continue to grow and form a crucial part of later releases which may use 6G communications networks. To meet the demand for increased wireless data traffic and to enable various vertical applications, efforts have been made to develop and deploy an improved 5th Generation (5G) and/or New Radio (NR) communication system specified by the Third Generation Partnership Project (3GPP).

As one of a technology for realizing a high speed of wireless communication networks, multiple-input multiple-output (MIMO) communication is essential. In MIMO communication, a plurality of antennas is included at both a transmitter side and a receiver side to realize spatially multiplexed streams. The MIMO communication method can facilitate increased transmission capacity, improved communication speed and high frequency use efficiency, without increasing a frequency band.

The wireless communications system includes one or more network communication devices such as base stations (also known as an eNodeB (eNB), a next-generation NodeB (gNB), NW etc.). Each network communication device, such as a base station, support wireless communications with one or more user communication devices (also known as user equipment (UE), terminal device etc.). One of the vital features of the MIMO communication is the channel state information (CSI) which is acquired by the base station. Particularly, acquisition of accurate CSI is necessary to realize an improved communication performance gain. The base station often employs associated UEs to monitor a channel or communication link between the base station and respective UEs, where the UEs monitor and collect information (CSI feedback) of the channel on behalf of the base station.

However, CSI feedback is usually large in traditional CSI feedback framework causing increased overhead. It is therefore desired to reduce (or compress) the CSI overhead while maintaining the improved/large MIMO performance gain. Traditionally, CSI feedback compression is performed using codebook-based methods. Recently, deployment of artificial intelligence (AI)/machine learning (ML) for compressing CSI feedback has gained significant traction. AI/ML-based CSI Compression involves a two-sided AI/ML model consisting of an encoder model (also known as generation model) at the UE and a decoder model (also known as reconstruction model) at the base station, wherein the encoder model is employed at the UE to compress the CSI feedback, while the decoder model at base station is employed to reconstruct the compressed CSI feedback. In its simplest form, both the encoder and decoder are jointly trained and then split up during deployment.

In real world deployment scenarios, a single base station can serve multiple UEs and a single UE can be served by multiple base stations. Consequently, implementations of AI/ML-based CSI compression often involve deploying and maintaining a plurality of encoder models at UE and a plurality of decoder models at base station (also known as two-sided model). A particular encoder model can be trained with one or more decoder models, and conversely, a particular decoder model can be trained with one or more encoder models.

The two parts of the two-sided model should work in tandem to perform compression and reconstruction. Not all encoder-decoder combinations can be used to achieve CSI compression. Based on various training methods, only a few encoder-decoder combinations can be deployed to perform AI/ML based CSI compression. It is desired to ensure the compatibility between the encoder and the decoder models for acquiring accurate CSI and realizing an improved communication performance gain.

The model training methods (or scenarios) for training of a two-sided model are as follows:
Type 1: Joint training of a two-sided model at a single side/entity (e.g., user equipment (UE)-sided or network-sided,
Type 2: Joint training of a two-sided model at both the network side and the UE side respectively, and
Type 3: Separate training at the network side and the UE-side, where the UE-side CSI generation part and the network-side CSI reconstruction part are trained by UE side and network side, respectively.

In order to achieve compatibility between the encoder and the decoder models of the two-sided model, certain pairing information needs to be defined.

From prior 3GPP standards meetings (RAN 1 #114 meeting [1] in August 2023), various options for pairing of encoder-decoder models have been proposed. The following options define the pairing information used to enable the UE to select an encoder model(s) that is compatible with the decoder model(s) used by the base station in CSI compression using two-sided model:
Option 1: The pairing information is in the forms of the CSI reconstruction model ID that NW will use.
Option 2: The pairing information is in the forms of the CSI generation model ID that the UE will use.
Option 3: The pairing information is in the forms of the paired CSI generation model and CSI reconstruction model ID.
Option 4: The pairing information is in the forms of by the dataset ID during type 3 sequential training.
Option 5: The pairing information is in the forms of a training session ID to a prior training session (e.g., API) between NW and UE.
Option 6: The pairing information is up to UE/NW offline co-engineering alignment.

It is further required to enhance physical layer signaling for AI/ML-based CSI compression techniques to reduce overhead and ensure compatibility in two-sided model.

An object of embodiments herein is to obviate the above-mentioned problems.

### OBJECTS OF THE INVENTION

An object of the present invention is to provide a method and apparatus for achieving model compatibility in AI/ML based channel state information compression models in multi-antenna systems (MIMO).

Yet another object of the present invention is to enhance physical layer signaling for AI/ML-based CSI compression techniques to reduce overhead.

### SUMMARY OF THE INVENTION

The summary is provided to introduce aspects related to transmission system and transmission method for an electric vehicle, and the aspects are further described below in the detailed description. This summary is not intended to identify essential features of the claimed subject matter, nor is it intended for use in determining or limiting the scope of the claimed subject matter.

In a preferred embodiment, the present invention describes a method to be performed by a UE. The method comprises transmitting an initial capability report to a base station. The method further comprises receiving an initial network configuration from the base station. The method further comprises transmitting an AI-specific AI/ML CSI capability report to the base station. The method further comprises receiving a CSI report configuration consisting of AI/ML model specific configuration parameters and CSI reporting parameters. The method further comprises receiving CSI-Reference signals. The method further comprises computing AI-CSI parameter based on the CSI report configuration and transmitting a CSI report. The CSI report configuration is transmitted according to an information element (IE) consisting of a pairing ID. The AI-CSI parameter is computed based on AI/ML model indicated by the pairing ID and other CSI reporting parameters included in the CSI report configuration.

In one aspect, the initial capability report indicates the capability of a UE to support the AI/ML assisted CSI feedback compression. The initial capability report also indicates information about factors supporting AI/ML assisted CSI feedback compression. The factors include at least one of environment, frequency-domain, antennas, variables pertaining to model development.

In one aspect, the AI/ML model specific configuration parameters may include Model ID indicating identified model, Model input type indicating raw channel or eigenvector, Model input size such as Tx antenna ports, Sub-band size, Compression ratio, Quantization type and Additional Quantization parameters depending on the quantization type.

In one aspect, the pairing ID in the information element (IE) indicates the most compatible model out of a plurality of AI/ML models.

In one aspect, the pairing information is generated based on the type of training method adopted for a two-sided model.

In one aspect, the pairing information is generated from training dataset or dataset ID in Type 3 training method.

In one aspect, the pairing information is generated from joint training information and joint training instance in in Type 1 and Type 2 training methods.

In one aspect, the pairing information is not generated when a UE-side encoder model is compatible with all base station-side models.

In one aspect, the method further comprises generating the pairing information during exchange of models or parameters or data between base station and UE.

In a preferred embodiment, the present invention describes a UE comprising a processor and a memory coupled to the processor. The processor is configured to transmit an initial capability report to a base station. The processor is further configured to receive an initial network configuration from the base station. The processor is further configured to transmit an AI-specific AI/ML CSI capability report to the base station. The processor is further configured to receive an CSI report configuration consisting of AI/ML model specific configuration parameters and CSI reporting parameters. The processor is further configured to receive CSI-Reference signals from the base station. The processor is further configured to compute AI-CSI parameter based on the CSI report configuration and transmit a CSI report. The CSI report configuration is transmitted according to an information element (IE) consisting of a pairing ID. The AI-CSI parameter is computed based on AI/ML model indicated by the pairing ID and other CSI reporting parameters included in the CSI report configuration.

Other objects, features and advantages of the present invention will be readily appreciated, as the same becomes better understood after reading the subsequent description taken in conjunction with the accompanying drawings.

### BRIEF DESCRIPTION OF THE DRAWINGS

The accompanying drawings constitute a part of the description and are used to provide a further understanding of the present invention. Such accompanying drawings illustrate the embodiments of the present invention used to describe the principles of the present invention. The embodiments are illustrated by way of example and not by way of limitation in the figures of the accompanying drawings in which references indicate similar elements. It should be noted that references to “an” or “one” embodiment in this invention are not necessarily to the same embodiment, and they mean at least one. In the drawings:

FIG. 1 illustrates an example of a communication system that supports a two-sided model in accordance with aspects of the present invention.

FIG. 2 illustrates a process flow that enables model compatibility techniques in a two-sided model of wireless communications in accordance with the present invention.

FIG. 3 illustrates the information element (IE) pertaining to the CSI report configuration.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below process flows illustrate example methods that can be implemented in accordance with the principles of the present invention and various changes could be made to the methods illustrated in the process flows herein. For example, while shown as a series of steps, various steps in each figure could overlap, occur in parallel, occur in a different order, or occur multiple times. In another example, steps may be omitted or replaced by other steps.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “according to one embodiment,” “in some embodiments,” “in some other embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

Approximating language, as used herein throughout the specification and claims, may be applied to modify any quantitative representation that could permissibly vary without resulting in a change in the basic function to which it is related. Accordingly, a value modified by a term or terms, such as “less than,” “approximately” etc. is not limited to the precise value specified. In some embodiments, the approximating language may correspond to the precision of an instrument for measuring the value.

The embodiments of the present invention are applicable to any communication system adopting AI/ML techniques for reducing overhead associated with CSI feedback.

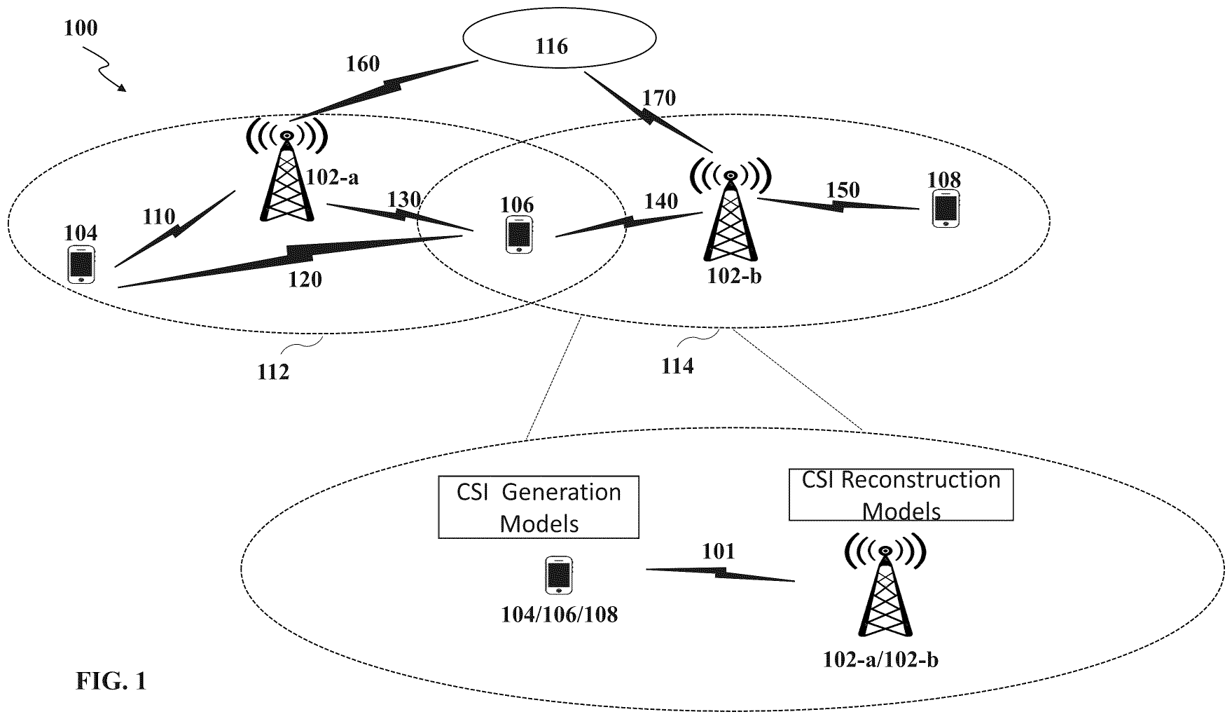

FIG. 1 illustrates an example of a communication system 100 that supports a two-sided model in accordance with aspects of the present invention. The wireless communication system 100 is associated with plurality of cells 112, 114 and includes a plurality of user equipment (UEs) 104, 106, 108 and base stations 102-a, 102-b in communication over the cells 112, 114 and a core network 116 via communication links 110, 120, 130, 140, 150, 160, 170. The communication links can be uplink or downlink, wherein uplink is the communication link for transmitting a signal from UE to base station and conversely, downlink is the communication link from the base station to the UE.

The wireless communications system 100 may support various radio access technologies, and may be a 4G network, such as an LTE network or a LTE-Advanced (LTE-A) network. In some other embodiments, the wireless communications system 100 may be a 5G network, such as an NR network. In other implementations, the wireless communications system 100 may be a combination of a 4G network and a 5G network and may support radio access technologies beyond 5G.

The discussion of 5G systems and technologies associated therewith is for reference. However, the present invention is not limited to any particular class of systems or the frequency bands associated therewith, and embodiments of the present disclosure may be utilized in connection with any frequency band. Various aspects of the present invention may be implemented in 5G systems, 6th Generation (6G) systems, or even later releases which may use a plurality of frequency bands.

The base stations 102-a, 102-b communicates with the UEs 104, 106, 108. Each base station 102-a, 102-b may provide communication coverage for a particular geographic area called cells 112, 114. An individual UE (for instance, UE 106) may be operated by more than one base station. Some UEs 104 and 108 may be operated by a single base station. A base station may provide communication coverage for a macro cell or other types of cells.

The present invention discusses several aspects of training Artificial Intelligence/Machine Learning (AI/ML) models in AI/ML-based Channel State Information (CSI) compression. Specifically, procedures for enhancing compatibility between encoder model (also known as CSI generation model) and decoder (CSI reconstruction model) of a two-sided model in MIMO communication systems are disclosed. Further, procedures for enhancing Radio Resource Control (RRC) Signaling are also described.

The present invention provides a method of identifying an information called pairing information 101 to be transmitted for achieving compatibility between an encoder model at UE 104/106/108 and a decoder model at base station 102-a/102-b. The pairing information 101 may depend on the type of training methods being adopted for a two-sided model.

In one implementation, a two-sided model adopts Type 1 training method which includes joint training of an encoder model (at UE) and a decoder model (at base station) at a single side/entity (in other words, either at base station or at UE).

In another implementation, a two-sided model adopts Type 2 training method which includes joint training of an encoder model (at UE) and a decoder model (at base station) at both UE and base station sides.

In both the implementations, the pairing information may be generated from joint training information (Option 3) and joint training instance (session ID). The Model IDs for both encoder model and decoder model may include common information pertaining to the joint training instance.

In another implementation, a two-sided model adopts Type 3 training method which includes performing separate training at base station-side and UE-side, where the UE-side CSI generation part and the network-side CSI reconstruction part are trained by UE side and network side, respectively. In various embodiments, the Type 3 training method starts with joint training of the two-sided model (Type 1) at either UE-side or base station-side. Thereby, the Type 3 training method offers more flexibility by allowing either entity to independently choose and train their respective models (encoder/decoder).

Further, Type 3 training method allows the following two embodiment/scenarios. In accordance with a first embodiment, the base station may perform joint training of the two-sided model using Type 1 training method to generate data such as ground truth inputs and corresponding encoder outputs. Then, the base station may share some or all of the data to the UE. The UE may train its own version of the encoder model using the shared data. The encoder model at the UE is configured to be compatible with a decoder model(s) at the base station(s), if and only if the training data used to separately train the encoder model is generated by the corresponding jointly trained model(s) at the base station(s).

In accordance with a second embodiment, the UE may perform joint training of the two-sided model using Type 1 training method to generate data such as decoder inputs and corresponding ground truth outputs. Then, the UE may share some or all of the data to the base station. The base station may train its own version of the decoder model using the shared data. The decoder model at the base station is configured to be compatible with an encoder model(s) at the UE(s), if and only if the training data used to separately train the decoder model is generated by the corresponding jointly trained model(s) at the UE(s).

In accordance with a third embodiment, three different two-sided models may be trained at a plurality of base stations BS1, BS2, BS3. A user equipment UE1 may train its encoder model using the shared data generated from only base station BS1 adopting Type 1 training method. In such a case, the UE1 encoder model may be compatible with only decoder model of BS1.

Alternatively, another UE i.e. UE2 may train its encoder model using the shared data generated from the plurality of base stations BS1, BS2, BS3 (adopting Type 1 training method). In such a case, the UE2 encoder model may be compatible with the decoder model of all of the plurality of base stations BS1, BS2, BS3.

Henceforth, for models trained using Type 3 training method, the pairing information may be generated from training dataset i.e. dataset ID (Option 4). The dataset ID is assigned during dataset transfer.

In the present invention, the shared data may include pairing information that may be generated based on the type of the training method adopted, i.e. Type 1 or Type 2 or Type 3 for a two-sided model.

It may be noted that in scenarios where each UE-side encoder model is compatible with all base station-side models, the pairing information may not be shared.

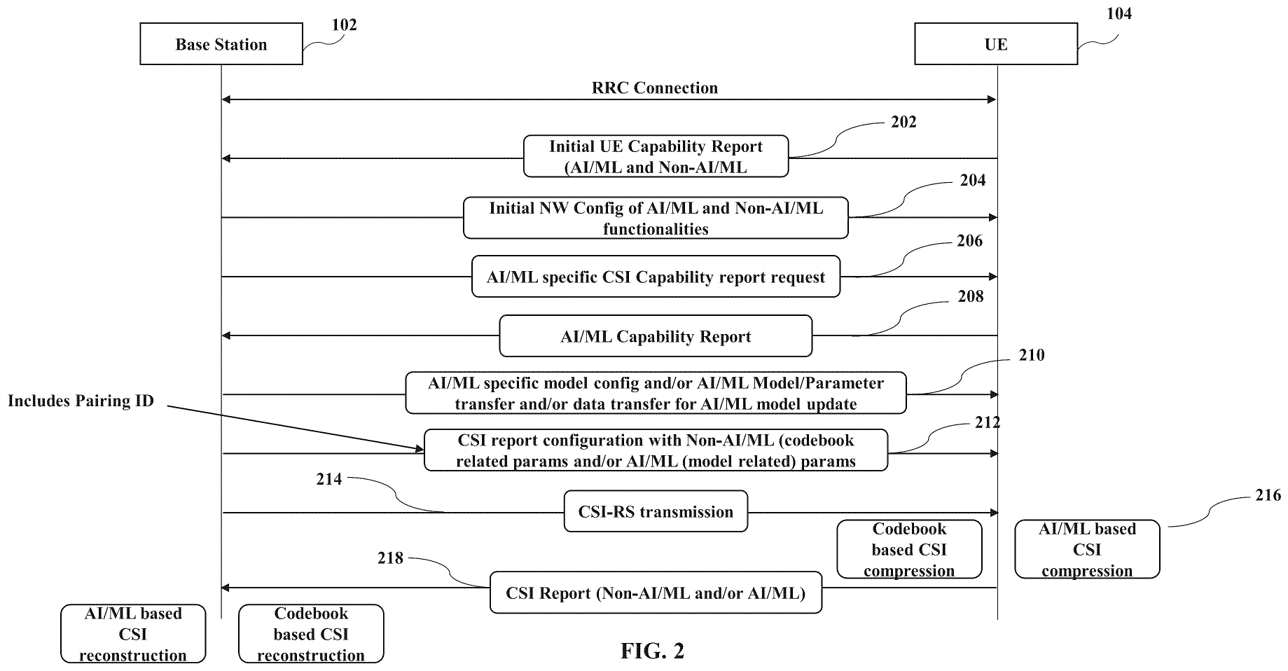

FIG. 2 illustrates a process flow 200 that enables model compatibility techniques in a two-sided model of wireless communications in accordance with the present invention. The process flow 300 may include a UE 104 and a base station 102. The UE 104 includes antennas, transceivers, processor, memory among other components. The processor is capable of executing programs and other processes resident in the memory to perform the process flow 200. The memory is coupled to the processor, and includes a RAM and/or ROM. The process flow 200 may illustrate an example of techniques which enable sharing of the pairing information for facilitating a compatible model selection from a plurality of AI/ML models (encoder or decoder). The UE 104 can either perform codebook-based CSI feedback compression or AI/ML model-based CSI feedback compression, and provide CSI report. The UE 104 and the base station 102 may use radio resource control (RRC) signaling to communicate (e.g., control channel signaling, shared channel signaling, or any combinations thereof). The signaling may not be considered in a restrictive sense, but may also be one or more of radio resource control (RRC) signaling, medium access control (MAC) control element (CE) signaling, physical layer signaling (e.g., a downlink control indication (DCI) and/or uplink control information (UCI)), or any combinations thereof.

At 202, the UE 104 may transmit an initial capability report to the base station 102. The initial capability report may indicate whether the UE 104 is capable to support AI/ML assisted CSI feedback compression and codebook (Non-AI/ML) based CSI compression. The initial capability report may comprise of the information about the factors supporting the AI/ML assisted CSI feedback compression using AI/ML models such as environment, frequency-domain, antennas, variables pertaining to model development and the like. The UE 104 may transmit an indication whether the UE 104 supports AI/ML based functionalities.

At 204, the base station 102 may transmit, and the UE 104 may receive, initial network configuration of the AI/ML and Non-AI/ML functionalities. The initial network configuration may include selection of one or more functionalities based on the reported supporting conditions. Additionally, at 206, the base station 102 may request for an (AI-specific) AI/ML CSI capability report from UE 104 to which the UE 104 may transmit the (AI-specific) AI/ML CSI capability report to the base station 102 at 208.

At 210, the base station 102 may transmit, and the UE 104 may receive, configurations for the AI/ML capabilities and/or the base station 102 may transmit, and the UE 104 may receive, model IDs or model parameters or any other data for updating AI/ML models. The pairing information may be generated during exchange of models or parameters or data between base station 102 and UE 104 (online collaboration).

At 212, the base station 102 may transmit, and the UE 104 may receive, CSI report configuration using RRC signaling. The CSI report configuration may include AI/ML and/or Non-AI/ML configurations such as the CSI reporting parameters (PMI, RI, CQI, LI, CRI), CSI configuration type (periodic, semi-persistent PUCCH, semi-persistent PUSCH, aperiodic), report frequency configuration (frequency granularity, i.e., wideband/subband), codebook configuration (Type-1/Type-2 codebook parameters). In accordance with the present invention, the CSI report configuration may comprise an additional report configuration (encoder-selectionConfig) relating to AI/ML model specific configuration parameters.

The AI/ML model specific configuration parameters may include, but not limited to, the following parameters:
Model ID (identified model)
Model input type (Raw channel or eigenvector)
Model input size (Tx antenna ports, Sub-band size)
Compression ratio
Quantization type
Additional Quantization parameters depending on the quantization type (for ex: number of bits)

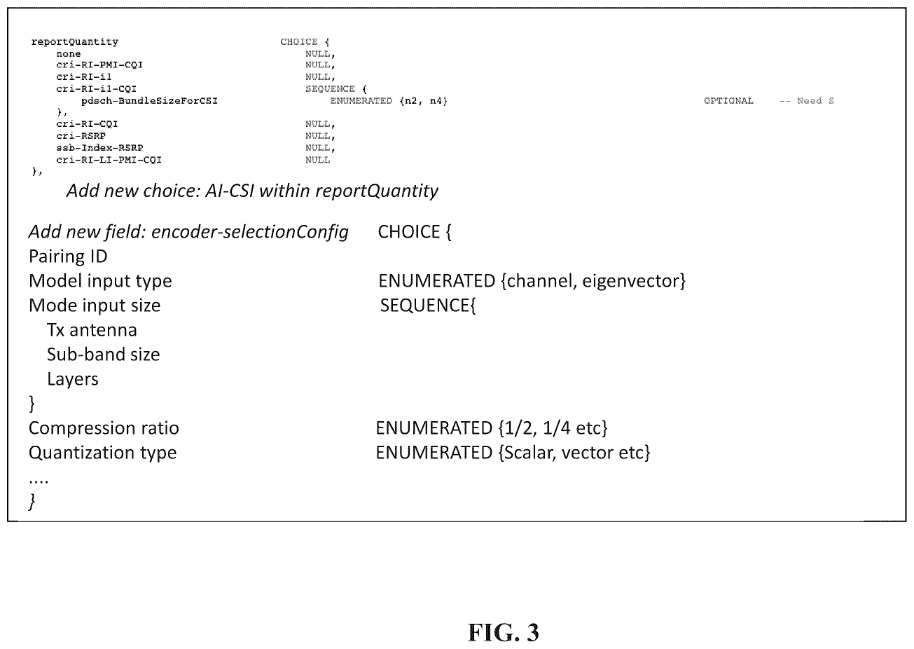

The CSI report configuration may consist of an additional field in the additional report configuration for including pairing information which may be referred to as “pairing ID” in an information element as illustrated in FIG. 3. FIG. 3 illustrates the information element (IE) pertaining to the CSI report configuration. The pairing ID may identify and indicate the most compatible model out of a plurality of AI/ML models, thereby ensuring compatibility in a two-sided model.

Subsequent to the transmission of the CSI report configuration, the base station 102 may transmit, and the UE 104 may receive, CSI-RS (Reference Signal) to the UE 104 at 214.

At 216, the UE 104, based on the configurations obtained in 210 and 212, may perform the CSI feedback compression. The UE 104 may compute necessary parameters such as AI-CSI based on AI/ML model indicated by the pairing ID and other CSI reporting parameters such as RI, CQI, and the like obtained from CSI report configuration.

At 218, the UE 104 may transmit, and the base station 102 may receive, a CSI report.

The terms “or” and “and/or” as used herein are to be interpreted as inclusive or meaning any one or any combination. Therefore, “A, B or C” or “A, B and/or C” may mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method, comprising:
transmitting an initial capability report to a base station;
receiving an initial network configuration from the base station;
transmitting an AI-specific AI/ML CSI capability report to the base station;
receiving a CSI report configuration consisting of AI/ML model specific configuration parameters and CSI reporting parameters;
receiving CSI-Reference signals from the base station;
computing AI-CSI parameter based on the CSI report configuration; and
transmitting a CSI report,
wherein the CSI report configuration is transmitted according to an information element (IE) consisting of a pairing ID, and
the AI-CSI parameter is computed based on AI/ML model indicated by the pairing ID and other CSI reporting parameters included in the CSI report configuration.

2. The method as claimed in claim 1, wherein the initial capability report indicates:
the capability of a UE to support the AI/ML assisted CSI feedback compression; and
information about the factors supporting AI/ML assisted CSI feedback compression, wherein the factors may include at least environment, frequency-domain, antennas, variables pertaining to model development.

3. The method as claimed in claim 1, further comprising receiving, from the base station, configurations for the AI/ML capabilities and/or model IDs or model parameters or any other data for updating AI/ML models.

4. The method as claimed in claim 1, wherein the AI/ML model specific configuration parameters include at least one of the following parameters:
Model ID indicating identified model;
Model input type indicating raw channel or eigenvector;
Model input size such as Tx antenna ports, Sub-band size;
Compression ratio;
Quantization type; and
Additional Quantization parameters depending on the quantization type.

5. The method as claimed in claim 1, wherein the pairing ID indicates the most compatible model out of a plurality of AI/ML models.

6. The method as claimed in claim 5, wherein the pairing information is generated based on the type of training method adopted for a two-sided model.

7. The method as claimed in claim 6, wherein the pairing information is generated from training dataset or dataset ID in Type 3 training method.

8. The method as claimed in claim 6, wherein the pairing information is generated from joint training information and joint training instance in in Type 1 and Type 2 training methods.

9. The method as claimed in claim 6, wherein the pairing information is not generated when a UE-side encoder model is compatible with all base station-side models.

10. The method as claimed in claim 6, wherein the pairing information is generated during exchange of models/parameters/data between NW and UE (online collaboration).

11. The method as claimed in claim 3, further comprising:
generating the pairing information during exchange of models or parameters or data between base station and UE.

12. A user equipment comprising:
a processor; and
a memory coupled to the processor, wherein the processor is configured to perform:
transmit an initial capability report to a base station;
receive an initial network configuration from the base station;
transmit an AI-specific AI/ML CSI capability report to the base station;
receive a CSI report configuration consisting of AI/ML model specific configuration parameters and CSI reporting parameters;
receive CSI-Reference signals from the base station;
compute AI-CSI parameter based on the CSI report configuration; and
transmit a CSI report,
wherein the CSI report configuration is transmitted according to an information element (IE) consisting of a pairing ID, and
the AI-CSI parameter is computed based on AI/ML model indicated by the pairing ID and other CSI reporting parameters included in the CSI report configuration.
